(19) United States
(12) Patent Application Publication
(10) Pub. No.: US 2007/0283370 A1
(43) Pub. Date: Dec. 6, 2007

(54) Optical disc drive

(76) Inventors: Masahiro Matsuo, Tokyo (JP); Yoichi Narui, Matsudo (JP); Ikuo Nishida, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/541,530

(22) Filed: Oct. 3, 2006

(30) Foreign Application Priority Data
May 30, 2006 (JP) 2006-149817

(51) Int. Cl. G11B 17/04; G11B 33/12

(52) U.S. Cl. 720/652; 720/601

(57) ABSTRACT

A flexible printed-wiring circuit board that connects a signal-processing circuit board and a pickup is prevented from coming into contact with the bottom (or the like) of a tray and thus becoming damaged. The flexible printed-wiring circuit board (FPC board) is disposed in a U-shaped folded state in a space sandwiched between a surface along which the tray moves, and a surface on which the signal-processing circuit board is mounted. An extension portion that restricts deformation of the FPC board toward the tray is provided at a connecting end of the pickup. Length D of the extension portion is set such that length S of the FPC board from a front end of the extension portion to a fold-back position of the FPC board is equal to or less than a required value.

### CLAIM OF PRIORITY

The present application claims priority from Japanese application serial no. JP 2006-149817, filed on May 30, 2006, the content of which is hereby incorporated by reference into this application.

### BACKGROUND OF THE INVENTION

(1) Field of the Invention

The present invention relates to optical disc drives for writing or reading out signals onto or from an optical disc. More particularly, the invention relates to a structure of a flexible printed-wiring circuit board that connects a pickup and a circuit board equipped with a signal-processing circuit.

(2) Description of the Related Art

Optical disc drives with an optical pickup adapted to enable emission of laser beams with three wavelengths including a blue laser beam are coming to be used in recent years. The dimension of the pickup tends to be increased. In the meantime, with a wide variety of use applications, there is a strong desire for the thinning-down and miniaturization of personal computers in which an optical disc drive is to be mounted regardless of whether the number of functions is increased. Optical disc drives are also requested to be thinned down and miniaturized.

The main inhibiting factor in achieving the thinning-down and miniaturization of optical disc drives is the presence of drive mechanism sections for mounting an optical disc, driving a pickup, etc. In terms of a wiring structure for exchanging signals with the pickup, a flexible printed-wiring circuit board (hereinafter, abbreviated to FPC board) that has durability against repeated operation for optical disc data reading/writing and is excellent in the ease of handling has been generally used in recent years as a technique for thinning the driving section of the pickup.

During connection of the FPC board and the pickup, the reliability of the connection may not be secured by using connectors. For this reason, the FPC board is connected to the pickup directly, instead of connectors. In the case where the FPC board is damaged, therefore, the pickup also requires replacement at the same time, and FPC board damage must be avoided. Also, the FPC board is structured such that it can be folded back in a U-shape state when moved, and a bend portion in the fold-back portion easily overhangs. During tray movement for mounting the optical disc or during pickup movement, FPC board damage will result if the overhanging portion of the FPC board comes into sliding contact with the tray member, the disc or other sections. There is a need, therefore, to avoid the sliding contact of the FPC board by suppressing the overhang of the FPC board toward the tray, and thus to prevent the occurrence of FPC board damage.

Techniques in connection with this are disclosed in Japanese Patent Laid-Open No. 2005-346871, Japanese Patent Laid-Open No. 2005-203039, Japanese Patent Laid-Open No. 2004-355772 and Japanese Patent Laid-Open No. 2004-234803, for example, which propose techniques for preventing damage to the bend in a FPC board.

### SUMMARY OF THE INVENTION

The disc drive described in above Japanese Patent Laid-Open No. 2005-346871 has a structure in which a pickup that is connected with a FPC board is mounted on a disc tray that is extends from and retracted into an enclosure. Hence, the total vertical space of the disc drive is limited and the width of the FPC board connected to the pickup is increased with an increase in the number of electrical signal lines to read out/write data from/onto many types of discs. As a result, the U-shaped fold-back portion of the FPC board planarly overlaps on the pickup opening in the tray, and the resulting upward movement of the FPC board's fold-back portion from the opening damages the disc being used. In order to solve this problem, a top cover that constitutes the tray is used to prevent disc damage by holding down the overhang of the FPC board. However, since sliding the overhang inward or downward moves the FPC board itself, FPC board damage due to sliding contact with the top cover could result, and since the repulsion of the stress due to the hold-down of the overhang is applied to the pickup section, the pickup could be misaligned.

The optical disc drive described in Japanese Patent Laid-Open No. 2005-203039 includes a mechanism for reading out and writing data from/onto a disc in a movable tray. The disc drive has an FPC board that connects a control circuit board disposed on the reverse side of the tray and a control circuit board placed on an enclosure, and the FPC board is bent to make the tray movable. Since the disc drive is small in thickness, there are the problems that if it is attempted to house the FPC board in the drive, the radius of curvature of the bend portion in the FPC board is reduced, thus making the FPC board prone to break, and resulting in wiring disconnections. In order to solve these problems, the bottom of the enclosure is notched and the radius of curvature of the bend is increased for the bend to jut out toward the notch portion, whereby the breakage of the FPC board is prevented. In this structure, it is assumed that the FPC board protrudes from the enclosure of the optical disc drive, so the particular relationship between the amount of protrusion and the position of the optical disc could lead to damage to the FPC board and the optical disc due to contact between them.

The optical disc drive described in Japanese Patent Laid-Open No. 2004-355772 is characterized in that an FPC board is pulled out toward a spindle motor. However, since a pickup needs to move close to the spindle motor in order to perform data read/write operations on an optical disc, the FPC board and the spindle motor could come into contact with each other and become damaged.

The recording and/or reproducing device described in Japanese Patent Laid-Open No. 2004-234803 uses an FPC board to establish electrical connection between a chassis and a pickup unit mounted on an extendible-retractable mobile body. In order to reduce the load on the FPC board due to movement of the mobile body, the bend region of the FPC board is formed more thinly than other regions of the FPC board. Varying the thickness of the FPC board from region to region, however, degrades the workability of the FPC board and is likely to result in a stress concentrated at the portions whose thicknesses change.

The present invention was made in view of these problems of the above conventional techniques, and an object of the invention is to provide an optical disc drive with high reliability by reducing an overhang of a fold-back portion of a flexible printed-wiring circuit board which connects a circuit board and a pickup, and avoiding contact between the flexible printed-wiring circuit board and other members.

An optical disc drive of the present invention includes: an enclosure; a tray on which to place an optical disc and which moves between a retracting position and an extending position with respect to the enclosure; a disc motor which rotationally drives the optical disc; a pickup which writes or reads out signals onto/from the optical disc; a pickup feeder which slides the pickup in a radial direction of the optical disc; a circuit board mounted on the enclosure and adapted for processing the signals that the pickup writes or reads out; and a flexible printed-wiring circuit board which electrically connects the pickup and the signal-processing circuit board and transmits the signals. The pickup has a connecting end member to connect the flexible printed-wiring circuit board, the flexible printed-wiring circuit board being disposed in a U-shaped folded state in a space sandwiched between a surface along which the tray moves and a surface on which the signal-processing circuit board is mounted, and the connecting end member having a restriction member to restrict deformation of the flexible printed-wiring circuit board toward the tray.

The connecting end member of the pickup includes, as the restriction member, an extension portion protruding toward the flexible printed-wiring circuit board.

Length D of the extension portion is set such that length S of the flexible printed-wiring circuit board from a front end of the extension portion to a fold-back position of the flexible printed-wiring circuit board is equal to or less than a required value.

According to the present invention, it is possible to provide a highly reliable optical disc drive that avoids contact of a flexible printed-wiring circuit board with other members of the optical disc drive.

### BRIEF DESCRIPTION OF THE DRAWINGS

FIG. 1 is an exploded perspective view showing an embodiment of an optical disc drive according to the present invention.

FIG. 2 is a sectional view showing the peripheral configuration of a pickup in the optical disc drive of FIG. 1.

FIGS. 3A, 3B are diagrams schematically showing deformation of a flexible printed-wiring circuit board (FPC board).

FIG. 4 is a diagram showing a relationship between an extension portion and the amount of an overhang of the FPC board.

FIGS. 5A and 5B are diagrams illustrating the deformation of the FPC board during movement of the pickup.

### DESCRIPTION OF THE PREFERRED EMBODIMENT

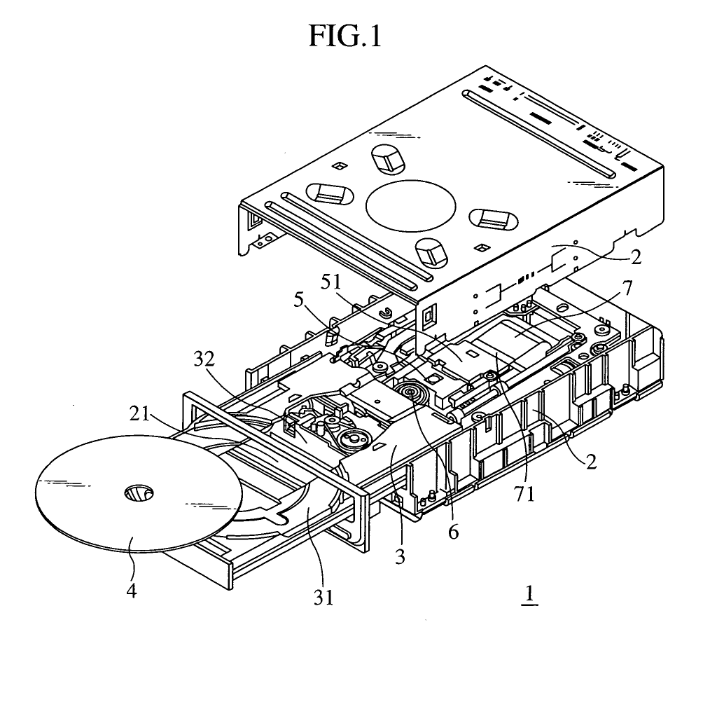

FIG. 1 is an exploded perspective view showing an embodiment of an optical disc drive according to the present invention. The optical disc drive 1 of the present embodiment includes an enclosure 2. In a front panel of the enclosure 2, an extending/retracting slot 21 for a tray 3 is provided. A concave portion 31 in which to place an optical disc 4, and an opening 32 for rendering a pickup 5 accessible to the optical disc 4 are formed in the tray 3. The tray 3 is constructed so as to be slidable with the optical disc 4 placed in the concave portion 31 between an extending position of the tray at which the tray is extended to an outside region of the enclosure 2 and a retracting position of the tray at which the tray is retracted into the enclosure. Upon completion of sliding to the retracting position, the tray 3 with the optical disc 4 placed on is positioned and held by a locking unit (not shown), and the optical disc 4 is engaged with a disc motor 6.

The optical disc 4 is rotationally driven by the disc motor 6, and the pickup 5 facing the optical disc 4 uses an optical lens to focus laser beams emitted from a semiconductor laser which is a light source, and writes or reads out a signal onto/from the optical disc 4. At this time, the pickup 5 is slidable in a radial direction of the optical disc 4 by a pickup feeder unit (not shown) at the opening 32 of the tray 3, and thus slides between the innermost peripheral position on the disc and the outermost peripheral position thereon.

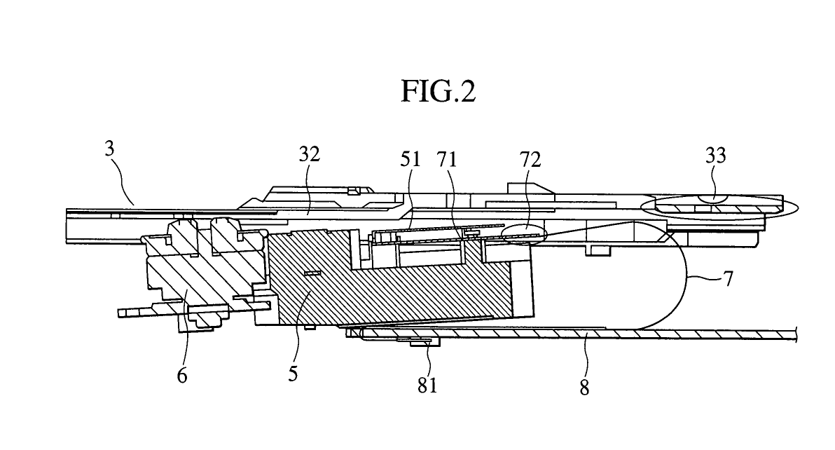

Through a flexible printed-wiring circuit board (hereinafter, referred to as FPC board) 7, the pickup 5 sends/receives the signal that the pickup writes or reads out to/from a circuit board 8 (shown in FIG. 2) mounted in a main unit of the disc drive in order to process the signal. During exchange of the signal, the pickup 5 and the FPC board 7 are electrically connected on a connecting end member 71 of the pickup 5 directly, instead of via a connector. In order to enhance heat release during operation, the pickup 5 also has a heatsink plate 51 as required.

FIG. 2 is a sectional view showing the peripheral configuration of the pickup in the optical disc drive of FIG. 1. During opening/closing of the tray 3, the pickup 5 and the disc motor 6 are inclined at a required angle so as to move (i.e., downward in FIG. 2) away from a sliding surface of the tray 3, thus making it easy to mount the optical disc. The pickup 5 and the circuit board 8 are connected by folding back the flexible printed-wiring circuit board (FPC board) 7. At this time, the pickup 5 and the FPC board 7 are connected on the connecting end member 71 of the pickup 5. Deformation of the FPC board 7 during the connection thereof with the pickup 5, however, is restricted by an extension portion 72 extending toward the FPC board 7. The extension portion 72 is provided in the connecting end member 71. The extension portion 72 is a restricting member that restricts the deformation of the FPC board 7 toward the tray 3 by protruding in a required distance from an edge of the pickup 5 or from an end of the heatsink plate 51. With the extension portion 72, the disc drive can prevent a fold-back portion of the FPC board 7 from coming into contact with a bottom portion 33 of the tray. In addition, propagation of heat which has been generated by the pickup 5, to the FPC board 7, is minimized since the heatsink plate 51 is receded from the extension portion 72.

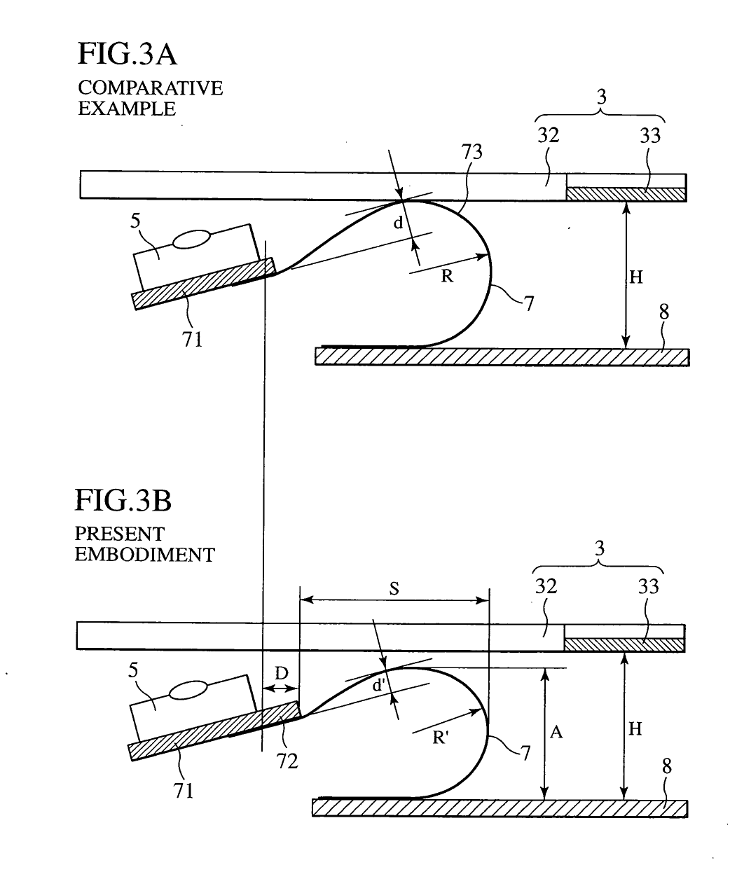

FIGS. 3A, 3B are diagrams schematically showing the deformation of the flexible printed-wiring circuit board (FPC board) 7 in FIG. 2. FIG. 3A shows a comparative example in which the extension portion 72 is not provided so that the connecting end member 71 is as long as the pickup 5, and FIG. 3B shows the present embodiment in which the connecting end member 71 includes the extension portion 72 of length D. Both FIGS. 3A and 3B show the case where the pickup 5 is positioned at which the deformation of the FPC board 7 becomes a minimum.

As shown in FIG. 3A, when the pickup 5 moves, a component force related to a radius R of curvature of the fold-back portion and the like deforms the FPC board 7 so that the FPC board 7 overhangs a distance “d” in a direction of the tray 3. As a result, overhanging portion 73 of the FPC 7 slides while being brought into contact with the bottom portion 33 of the tray 3, and could damage the FPC board 7.

In FIG. 3B, in order to suppress the overhang of the FPC board 7, the connecting end member 71 has the extension portion 72 of length D which serves as a restrictor to restrict the deformation of the FPC board 7. As a result, the portion of the FPC board 7 which abuts on the extension portion 72 is not deformed toward the tray 3, the radius of curvature of the fold-back portion of the FPC board 7 is reduced to R′, and the amount of the overhang is reduced to “d′”. This means that it is possible to prevent the overhanging portion 73 of the FPC 7 from coming into sliding contact with the bottom portion 33 of the tray 3, and thus to avoid damaging the FPC board 7. In other words, if the width of a space sandwiched between a bottom portion 33 of the tray 3 and an upper plane of the circuit board 8 is defined as H, it is possible to maintain a relationship of R′<H/2.

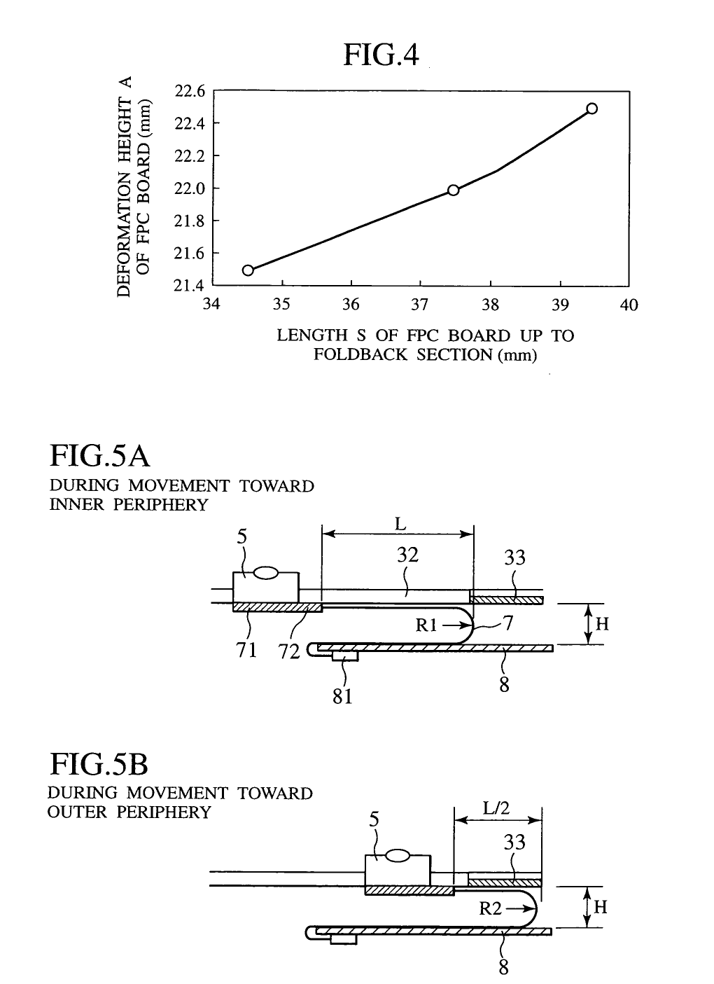

Next, FIG. 4 is a diagram in which measurement results on a relationship between the extension portion 72 and the amount of the overhang of the FPC board 7 are shown to illustrate advantageous effects of the present embodiment. In FIG. 4, a relationship between length S of the FPC board to the fold-back portion thereof and height A of the FPC board during the deformation thereof is shown with varying length D of the extension portion 72. Both dimensions S and A are shown in FIG. 3B. In FIG. 4, the FPC board is formed of polyimide. The FPC board is 30.7 mm in width, 0.1 mm in thickness, and the extension portion 72 is 0.3 mm in thickness. The amount of the overhang of the FPC board 7 depends on length S from the front end of the extension portion 72 to the fold-back position of the FPC board 7, not directly on length D of the extension portion 72. In addition, as length S (i.e., increasing length D of the extension portion) is reduced, the deformation height A (the amount of the overhang) of the FPC board is reduced. If a maximum permissible value of deformation height A is 22 mm, for example, the extension portion 72 should be provided so that length S of the FPC board to the fold-back portion is equal to or less than 37.5 mm. Since a deformation level of the FPC board 7 depends on particular machine characteristics (rigidity), an appropriate value should be set to suit the type of a FPC board used.

FIGS. 5A and 5B are diagrams illustrating the deformation of the flexible printed-wiring circuit board (FPC board) 7 during the movement of the pickup in the present embodiment. FIG. 5A shows the state where the pickup 5 is present at the innermost peripheral position on the optical disc 4, and FIG. 5B shows the state where the pickup 5 is present at the outermost peripheral position on the optical disc 4. The pickup 5 returns to its original horizontal position and slides from an inner peripheral edge of the disc to an outer peripheral edge thereof while facing the opening 32 in the tray 3 horizontally. As the pickup 5 slides, the FPC board 7 also moves. The length of the FPC board 7 up to the fold-back portion thereof is L in FIG. 5A, and L/2 in FIG. 5B.

In the present embodiment, the connecting end member 71 includes the extension portion 72. The extension portion 72 restricts the deformation of the FPC board 7. That is, the extension portion 72 is provided to suppress the length of the FPC board 7 up to the fold-back portion thereof to the required value or less. Although the maximum length of the FPC board 7 to the fold-back portion is L in FIG. 5A, the length L should be, for example, the maximum permissible value of 37.5 mm or less as shown in FIG. 4.

Thus, the amount of the overhang of the fold-back portion is reduced, the radius of curvature R can be decreased. When the pickup 5 moves, the FPC board 7 is placed into a space (width H) sandwiched between the bottom portion 33 of the tray 3 and the upper plane of the circuit board 8. Therefore, the FPC board 7 moves without overhanging toward the opening 32 or coming into contact with the bottom portion 3 of the tray 3. That is, the radii of curvature R1 and R2 of the fold-back portion in FIGS. 5A and 5B are always maintained in relationships of R1<H/2 and R2<H/2, respectively. This makes it possible to prevent the FPC board 7 from coming into sliding contact with the bottom portion 33 of the tray 3, even during the movement of the pickup 5, and hence to avoid damaging the FPC board 7.

In addition, in the present embodiment, since the moving distance L/2 of the fold-back portion of the FPC board 7 is ½ of the moving distance L of the pickup 5, the fold-back portion suffers no damage due to being pressed against a rear wall and other portions of the disc drive. For these reasons, the FPC board in the present embodiment does not come into sliding contact with other members of the FPC board, and the FPC board thus improves in reliability.

While the embodiment described above uses the structure using a flexible printed-wiring circuit board (FPC board), the present invention is also effective for cases using a flexible flat cable (FFC). In addition, while the connecting end member 71 and the extension portion 72 are integrally structured, the extension portion may be structured as an independent component. Furthermore, if the extension portion is formed to warp toward the circuit board 8 instead of forming the extension portion to be flat, the overhang of the FPC board can be reduced more significantly.

What is claimed is:

1. An optical disc drive comprising:
an enclosure;
a tray which moves between a retracting position and an extending position with respect to the enclosure, the tray on which an optical disc is placed;
a disc motor which rotationally drives the optical disc;
a pickup which writes signals or reads out the signals onto/from the optical disc;
a pickup feeder which slides the pickup in a radial direction of the optical disc;
a circuit board which is mounted on the enclosure, and processes the signals that the pickup writes or reads out; and
a flexible printed-wiring circuit board which electrically connects the pickup and the signal-processing circuit board and transmits the signals;
wherein:
the pickup includes a connecting end member to connect the flexible printed-wiring circuit board;
the flexible printed-wiring circuit board is disposed in a U-shaped folded state in a space sandwiched between a surface along which the tray moves and a surface on which the circuit board for processing the signals is mounted; and
the connecting end member includes a restriction member to restrict deformation of the flexible printed-wiring circuit board toward the tray.

2. The optical disc drive according to claim 1, wherein
the connecting end member of the pickup includes, as the restriction member, an extension portion that protrudes toward the flexible printed-wiring circuit board.

3. The optical disc drive according to claim 2, wherein
length D of the extension portion is set such that length S of the flexible printed-wiring circuit board from a front end of the extension portion to a fold-back position of the flexible printed-wiring circuit board is equal to or less than a required value.

4. The optical disc drive according to claim 2, wherein
the extension portion is formed to warp toward the circuit board for processing the signals.

5. The optical disc drive according to claim 1, wherein
when the tray moves between the retracting position and the extending position with respect to the enclosure, the restriction member restricts the deformation of the flexible printed-wiring circuit board in order to prevent the tray and the flexible printed-wiring circuit board from coming into contact with each other.

6. The optical disc drive according to claim 5, wherein:
when the tray moves between the retracting position and the extending position with respect to the enclosure, the pickup and the disc motor are disposed in an inclined state at a required angle so as to move away from a sliding surface of the tray; and
if a radius of curvature R formed at a fold-back portion of the flexible printed-wiring circuit board is defined as R′, and the width of a space sandwiched between a bottom portion of the tray and an upper plane of the circuit board for processing the signals is defined as H, a relationship of R′<H/2 is maintained.

7. The optical disc drive according to claim 1, wherein
when the pickup slides in the radial direction of the optical disc, the restriction member restricts the deformation of the flexible printed-wiring circuit board in order to prevent the tray and the flexible printed-wiring circuit board from coming into contact with each other.

8. The optical disc drive according to claim 7, wherein
if a radius of curvature formed at a fold-back portion of the flexible printed-wiring circuit board when the pickup moves to the innermost peripheral position of the optical disc is defined as R1, a radius of curvature formed at the fold-back portion of the flexible printed-wiring circuit board when the pickup moves to the outermost peripheral position of the optical disc is defined as R2, and the width of a space sandwiched between a bottom portion of the tray and an upper plane of the circuit board for processing the signals is defined as H, relationships of R1<H/2 and R2<H/2 are maintained.

9. The optical disc drive according to claim 1, wherein
when the tray moves between the retracting position and the extending position with respect to the enclosure, the restriction member restricts the deformation of the flexible printed-wiring circuit board such that the flexible printed-wiring circuit board comes into contact only with the pickup, the circuit board for processing the signals, and the restriction member.

10. The optical disc drive according to claim 1, wherein
when the pickup slides in the radial direction of the optical disc, the restriction member restricts the deformation of the flexible printed-wiring circuit board such that the flexible printed-wiring circuit board comes into contact only with the pickup, the circuit board for processing the signals, and the restriction member.
